(19) United States
(12) Patent Application Publication
(10) Pub. No.: US 2006/0096012 A1
(43) Pub. Date: May 11, 2006

(54) Wiper blade apparatus

(76) Inventor: Nicholas De Grunwald, Miiddlesex (GB)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/523,303

(22) PCT Filed: Jul. 31, 2003
(86) PCT No.: PCT/GB03/03342

§ 371 Date: Sep. 22, 2005

(30) Foreign Application Priority Data
Aug. 1, 2002 (GB) 0217915.8

(51) Int. Cl. A42B 1/08; B60S 1/56; B60S 1/04

(52) U.S. Cl. 2/424; 15/250.3; 15/250.001; 15/250.31

(57) ABSTRACT

There is disclosed a wiper blade apparatus (1). The wiper blade apparatus is suitable for use with protective headgear, the headgear for example including a visor. The apparatus disclosed includes a visor (2), at least one wiper blade (3), a motor (4) for driving the wiper blade (3) and attachment means (5) for attaching the apparatus (1) to the headgear (10) and for retaining the visor (2) of the apparatus (1) on a visor (11) of the headgear (10). The device of the invention can be fitted to a motorcycle helmet.

The present invention relates to wiper blade apparatus and in particular to a wiper apparatus suitable for use with protective headgear of the type including a visor, the device provided for removing drops of rain or snow etc from a user's field of vision.

Protective headgear, usually a helmet, is worn in order to prevent, or try to prevent, head injury and head-related injury to the wearer, for example a motorcyclist, in the event of an accident. Protective headgear, such as a helmet, is commonly fitted with a visor. The visor is designed to protect the wearer's eyes and face. The visor is usually attached at pivoting points provided at the side of the helmet, enabling the visor to be lowered from a raised position on the helmet (“above face”) to a protective position across the wearer's field of vision (“in front of face”).

Vision through the visor of the protective headgear is satisfactory and the visor serves a useful, protective purpose in good and average weather conditions. However, in inclement weather conditions with precipitation such as rain, sled or snow, drops of water and/or ice can collect on the visor, severely obscuring the wearer's vision. This is particularly a problem for motorcyclists as they are exposed to weather conditions while driving. In addition, the visor of a motorcycle helmet worn by a motorcyclist travelling at speed can collect insects and road debris such as dirt and oil, which can also obscure and hamper the motorcyclist's vision. It is important for a motorcyclist's vision and viewing range to be as clear as possible, an obscured or impeded view is dangerous and can cause or contribute to road traffic accidents.

One current method used by motorcyclist: to address the problem of debris and precipitation collecting on the visor is to clear the visor by wiping the visor manually, for example with a glove or cloth. Some wiping devices available are designed to be attached or put onto motorcycle gloves to aid the motorcyclist using this method of cleaning the visor. For example, the Vee-Wipe device available from Bob Heath Visors, Ltd is a wiper blade implement that is put on the index finger of the glove The wearer of the protective headgear, for example the motorcyclist, may also use the simple technique of raising, or removing the visor when the outer surface has collected debris or droplets of ice and water, in order that the field of vision is not obscured. This is achieved for example in most motorcycle helmets by manually pushing the visor above eye level, swivelling the visor on pivot pins or points provided either side of the helmet. The visor is pivoted from all “in front of face” to an “above face” position. However, in an “above face” position the motorcyclist's face and eyes are openly exposed to the weather conditions, the exposure is undesirable in poor weather conditions and the vision provided is limited and potentially dangerous.

More complicated wiping devices, such as those described in GB 2169497 provide a wiper blade specially adapted to be driven across a visor or windscreen using a driving mechanism permanently fixed or fitted directly to a motorcycle helmet visor or to a vehicle.

The disadvantage with such prior art wiping devices is that they require special manufacture and components as they are designed to operate over the curved surfaces usually found on visors or windscreens.

It is therefore desired to provide an improved wiper blade apparatus for protective headgear of the type including a visor, for example a motorcycle helmet, for use in keeping a wearer's view clear, particularly in inclement weather with precipitation, without requiring adaptation of the apparatus to the typically curved shape of the visor.

According to a first aspect of the present invention there is provided a wiper blade apparatus for protective headgear of the type including a visor, the apparatus comprising a visor, at least one wiper blade, a motor for driving said wiper blade and attachment means for attaching said apparatus to said headgear and for retaining the visor of the apparatus on a visor of the headgear.

The invention advantageously provides a device for ensuring a user of protective headgear, such as a motorcyclist, has a clear, unobscured view and field of vision during inclement weather including snow and rain, without requiring the user to manually wipe the visor surface themselves. The user can therefore more fully concentrate on the situation in front of them. In the example of a motorcyclist wearing a motorcycle helmet in heavy rain, the device of the present invention fitted to the helmet enables the motorcyclist to concentrate filly on the road situation thus, avoiding a possible accident.

In a preferred embodiment the visor of the apparatus comprises a substantially flat front panel and a seal for sealing the apparatus with the visor of the headgear. Preferably the visor front panel is made of a durable material, such as plastic or glass. A plastic front panel may be manufactured by moulding or other similar technique known in the art. The visor may be tinted or coloured to provide enhanced visibility and/or contrast in particular conditions. The exact size of the flat front panel can be varied depending on the wearer's requirements and the shape of the protective headgear including a visor that the apparatus is fitted to.

The visor of the apparatus is retained in place in front of and overlying a portion of the visor of the headgear. The visor of the apparatus, when fitted in place over the visor of We headgear, has a central portion of the flat front panel of the visor in line with a portion of the visor of the headgear.

Advantageously a substantially flat front panel provides a suitable surface for wiping with conventional, straight wiper blades. The blades can be moved across the flat surface with standard, readily available driving means, such as a battery powered motor device. The device may be solar powered. The batteries may be rechargeable. This advantageously means the device can be made with simple, readily available components reducing manufacturing costs. A power source, switch, battery pack and motor may be provided at any convenient position on the apparatus.

Preferably the seal of the visor extends around substantially all of the edges of the front panel of the visor. This is desirable so that rain, dirt, insects etc. cannot enter the gap between the visor of the headgear and the visor of the apparatus, obscuring the user's vision or distracting the user's attention.

More preferably the seal of the visor of the apparatus comprises flexible material for fitting the visor of the apparatus closely to the visor of the protective headgear. The flexible material may be rubber or a similar flexible material.

The apparatus may further include ventilation means for ventilating the space between the visor of the apparatus and the visor of the headgear. This advantageously reduces or eliminates mist and condensation that could build up on the inner surface of the visor of the apparatus due to temperature difference between the warm visor of the headgear (close to the user's body) and the cooler visor of the apparatus exposed to the outside environment.

The apparatus may include two wiper blades. This advantageously provides design flexibility and can mean that a larger visor can be wiped, or a small visor can be wiped and cleaned more efficiently than can be achieved with a single wiper blade. The wiper blades are preferably made of material such as rubber and are mounted, preferably, on steel rods or moulded plastic rods.

In a preferred embodiment the attachment means includes means for releasably securing the apparatus to the headgear. This enables the apparatus to be placed over the visor of the headgear and secured only when the user requires the apparatus, i.e. in poor (e.g. rain and/or snow) weather conditions. Advantageously the apparatus does not have to be attached permanently to the protective headgear.

Preferably the attachment means includes at least one strap or band member. More preferably attachment means comprise means for releasably securing the strap or band member to the headgear, enabling quick, versatile, easy, attachment, disengagement and re-attachment to the strap or band member.

Preferably the securing means for releasably securing can be fixed to the protective headgear. The securing means may be fixed with adhesive such as double-sided self adhesive tape, preferably of the type suitable for outdoor use.

Securing means fixed to the headgear is an advantageous feature of the present invention as it enables the apparatus to be secured quickly when required, without the user having to locate and secure separate, auxiliary securing means and fix that to the outer surface of the headgear. The apparatus is most often required in bad weather when speed is important as weather conditions change rapidly. In addition, separate securing means not fixed to the headgear could become lost or mislaid easily.

Preferably the attachment means includes a clip, cleat, book, barb or other retaining means. This type of attachment means provides quick and easy attachment of the apparatus to the protective headgear, and/or of the attachment means to the headgear. Quickly attaching the apparatus is advantageous in suddenly changing weather conditions, such as a storm or a sudden shower.

The attachment of the apparatus will be described below and can involve attachment means in the form of a strap fitted over the outer surface of protective headgear to retain the visor of the apparatus on the visor of the headgear. The outer surface of protective headgear such as a standard motorcycle helmet is smooth, thus it is likely that when a user raises a visor of the protective headgear the apparatus will no longer be fixedly attached to the protective headgear as the attachment strap will probably slide up the outside of the protective headgear under tension. Advantageously, providing a clip type securing means alleviates this problem.

More preferably, the attachment clip means may be replaceable. The clip, cleat, hook or barb means described above may be made of durable, waterproof material such as metal or moulded plastic.

Preferably the attachment means includes an elastic portion. Elastic portion(s) advantageously provide an adaptable, flexible attachment means, suitable for fitting to a variety of sides of protective headgear.

Preferably all or any pan of the attachment means is replaceable, advantageously providing longevity for the apparatus. The attachment means may comprise, for example, an elastic fabric portion, which may degrade before the other elements of the apparatus. Thus the replaceable attachment means could be removed and replaced prolonging the useful life of the device. Alternatively users may replace the attachment means with attachment means of another type for design or aesthetic reasons.

Embodiments of the present invention will now be described by way of example only, and with reference to the accompanying drawings, in which:

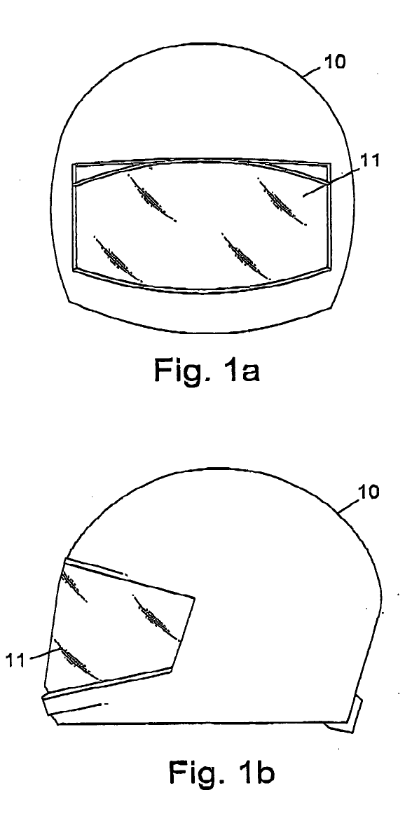

FIG. 1a shows a front view and FIG. 1b shows a side view of a conventional standard full face motorcycle helmet and visor.

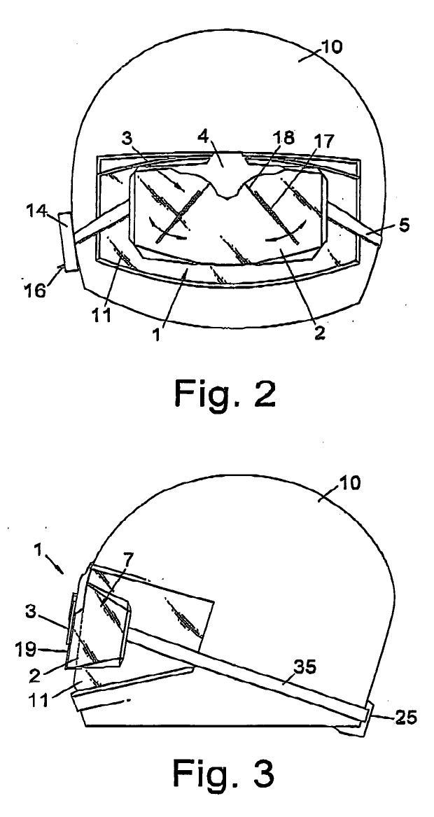

FIG. 2 shows a front view of the wiper blade apparatus of the present invention fitted to a conventional standard full face motorcycle helmet.

FIG. 3 shows the side view of the wiper blade apparatus of FIG. 2.

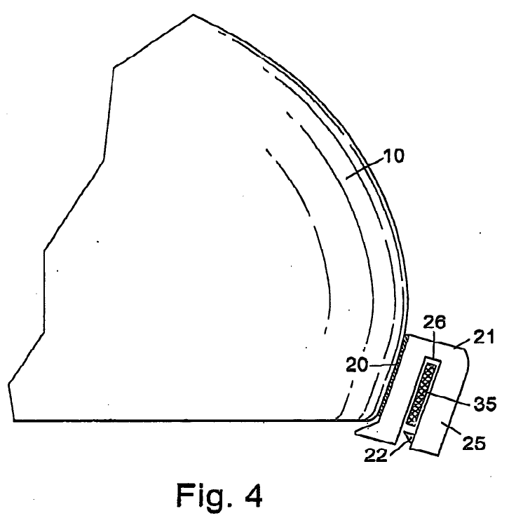

FIG. 4 shows part of the attachment means of the present invention, in detail, in side view on a conventional motorcycle helmet.

Referring to the drawings, there is shown wipe blade apparatus 1 for protective headgear 10 of the type including a visor 11, the apparatus 1 comprising a visor 2, at least one wiper blade 3, motor 4 for driving said wiper blade 3 and attachment means 5 for attaching said apparatus 1 to said headgear 10 and for retaining the visor 2 of the apparatus 1 on a visor 11 of the headgear 10.

Referring to the drawings, FIG. 2 shows an embodiment of the wiper blade apparatus 1 of the present invention wherein the protective headgear 10 is a standard full face motorcycle helmet and attachment means 5 includes a strap member 35 and attachment clip 25.

The visor of the apparatus is retained in place in front of and overlying a portion of the visor of the headgear. The visor of the apparatus, when fitted in place over the visor of the headgear has a central portion of the flat front panel of the visor in line with a portion of the visor of the headgear. The apparatus 1 is secured to helmet 10 and to visor 11 of to helmet, by use of strap member 35 and clip 25.

The embodiment shown in FIGS. 2 and 3 comprises a motor, 4, a battery power source, 14, and a power switch, 15, for controlling and driving the wiper blade, 3. The embodiment further comprises attachment strap 35, and attachment clip 25.

Referring to FIGS. 2, 3 and 4 the components and the operation of the wiper blade apparatus in accordance with the invention will now be described.

The visor 2 of the apparatus 1 of the invention comprises a substantially flat front panel 19 made from hard, durable, transparent plastic material. The substantially flat front panel 19 is of suitable width and dimension to provide a clear field of vision for the wearer.

In the preferred embodiment visor 2 includes a seal 7 extending around substantially all of the edges of the front panel of visor 2. Seal 7 is made of flexible rubber material, which fits closely to visor 11 of helmet 10. Thus, rain, dirt etc. are prevented from entering the gap in between visor 2 of apparatus 1 and visor 11 of helmet 10. Visor 2 also includes ventilation means in the form of ventilation holes (not shown) in rubber seal 7, which reduces the formation of condensation and mist on the inside of visor 2.

Apparatus 1 further includes two wiper blades 3, made of rubber blades 17 mounted on steel rods 18.

In use, the driving mechanism, described below, drives the wiper blades (3, 17, 18) across flat front panel 19 of visor 2. Thus, providing effective cleaning of that front panel. In the embodiment illustrated in FIGS. 2 and 3 wiper blades 3 are driven by motor 4, such as an actuator motor mechanism, for example DC motor, Model No. RE 10, available from Maxxon Motor. Motor 4 is housed in a moulded plastic case and is situated on visor 2 as shown in FIGS. 2 and 3. Motor 4 is powered by a separate, discrete, battery pack 14, with power on-off switch 15 located conveniently for the wearer on apparatus 1.

In use, motor 4 alternately drives wiper blades 3 such that the blades 3 move first towards each other and then in a direction such that the blades move away from each other (or vice versa) as indicated by arrows illustrating the wiper motion on FIG. 2. Alternatively, motor 4 drives wiper blades 3 in the same direction as each other, alternately causing wiper blades 3 to move towards one edge of visor 2 and then towards an opposing edge of visor 2.

In the preferred embodiment illustrated in FIGS. 2, 3 and 4 attachment means 5, of apparatus 1 includes an elastic strap 35. Strap 35 is a replaceable, interchangeable feature of apparatus 1. Strap 35 co-operates with a clip 25. Clip 25 is permanently or semi-permanently attached to the helmet 10 using an adhesive 20. Adhesive 20 is suitable for outdoor use.

Referring now to FIG. 4, illustrating in detail one embodiment of the attachment means of the present invention the attachment of the apparatus to the helmet 10 will now be described.

Attachment occurs subsequent to the motorcyclist having purchased the helmet 10 and after the motorcycle user has purchased the apparatus of the present invention as an addition to the helmet i.e. the apparatus of the present invention is designed to be an additional and complimentary auxiliary device for the motorcyclist.

When the motorcyclist wishes to use the apparatus of the present invention, usually in bad weather conditions etc. apparatus 1 is removed from a storage location and the motorcyclist places visor 2 of the apparatus in place over and on top of visor 11 of helmet 10. The strap 35 is pulled tight and taut up over the crown of helmet 10 and back behind helmet 10 to engage with the clip 25 and the recess 26, as shown in FIG. 4.

The clip 25 may include a barb 22 for retaining attachment strap 35 in recess 26. In use apparatus 1 is retained securely on visor 11 of helmet 10, even when a wearer raises visor 11 of helmet 10 to an ‘above face’ position on helmet 10. When apparatus 1 is in place power switch 15, connected to battery pack 14 is switched ‘ON’ to power motor 4 to drive wiper blades 3 across flat panel 19 of visor 2. Visor 2 is cleared of droplets of water, insects, debris etc by the movement of blades 3. When apparatus 1 is no longer required the motorcyclist removes apparatus 1 from helmet 10 by removing strap 35 from clip 25.

It will be appreciated that the above described embodiments are given by way of example only and that various modifications thereto are made without departing from the scope of the invention as defined in the appended claims.

For example the apparatus could be used on other types of protective headgear where it is important that the wearer has a clear, unobstructed view and where that view may be impaired by external debris or weather conditions. Examples of other types of protective headgear are helmets for racing car drivers or helmets with visors such as used by security forces, such as the police or other security staff.

1. A wiper blade apparatus for protective headgear of the type including a visor, the apparatus comprising a visor, at least one wiper blade, a motor for driving said wiper blade and attachment means for attaching said apparatus to said headgear and for retaining the visor of the apparatus on a visor of the headgear.

2. An apparatus as claimed in claim 1 wherein the visor of the apparatus comprises a substantially flat front panel and a seal for sealing the apparatus with the visor of the headgear.

3. An apparatus as claimed in claim 2 wherein the seal of the visor extends around substantially all of the edges of the front panel of the visor.

4. An apparatus as claimed in claim 2 or claim 3 wherein the seal of the visor of the apparatus comprises flexible material for fitting the visor of the apparatus closely to the visor of the headgear.

5. An apparatus as claimed in any preceding claim further including ventilation means for ventilating the space between the visor of the apparatus and the visor of the headgear.

6. An apparatus as claimed in any preceding claim wherein the apparatus includes two wiper blades.

7. An apparat as claimed in any preceding claim wherein said attachment means includes means for releasably securing the apparatus to the headgear.

8. An apparatus as claimed in any preceding claim wherein said attachment means including at least one strap or band member.

9. An apparatus as claimed in claim 8 wherein said attachment means further includes means for releasably securing the strap or band member to the headgear.

10. An apparatus as claimed in claim 7 or 9 wherein said means for releasably securing is fixed to the headgear.

11. An apparatus as claimed in any preceding claim wherein the attachment means includes a clip, cleat, hook or barb.

12. An apparatus as claimed in any proceeding claim wherein the attachment means includes an elastic portion.

13. An apparatus as claimed in any preceding claim wherein all or any part of the attachment means is replaceable.

14. An apparatus as hereinbefore described with reference to and/or substantially as illustrated in any one of or any combination of FIGS. 2-4.
